(19) United States
(12) Patent Application Publication
(10) Pub. No.: US 2026/0045180 A1
(43) Pub. Date: Feb. 12, 2026

(54) PROSTATE SURGERY SIMULATOR

(71) Applicant: ALDAVER INC., Daejeon (KR)

(72) Inventors: Ye Rim LEE, Daejeon (KR); Jaeho OH, Daejeon (KR); Jin-Oh KIM, Daejeon (KR)

(21) Appl. No.: 19/359,717

(22) Filed: Oct. 16, 2025

Related U.S. Application Data
(63) Continuation of application No. PCT/KR2023/018002, filed on Nov. 9, 2023.

(30) Foreign Application Priority Data
Aug. 22, 2023 (KR) 10-2023-0110109

(51) Int. Cl. G09B 23/32

(52) U.S. Cl. CPC G09B 23/32

(57) ABSTRACT

Provides is a prostate surgery simulator including an artificial structure that simulates a shape of a penis, a prostate, and a bladder, in which the prostate includes an abnormally enlarged inner gland and an outer glandular membrane that surrounds the inner gland, the penis, prostate, and bladder are internally connected through a urethra, and the artificial structure includes a structure in which a verumontanum, an obstruction kissing part, and a bladder neck are sequentially formed on the urethra toward the bladder.

### TECHNICAL FIELD

The present disclosure relates to a prostate surgery simulator.

### BACKGROUND ART

In general, a benign prostatic hyperplasia is a symptom in which a prostate becomes abnormally enlarged and blocks the prostate urethra, which is the passage of urine from the lower part of the bladder, causing urethral obstruction and making it difficult to discharge urine. When the benign prostatic hyperplasia occurs, symptoms such as frequent urination, nocturia, urgency, dribbling, and a feeling of residual urine appear, causing significant inconvenience in daily life.

The most effective treatment for the benign prostatic hyperplasia is surgery. Traditional surgical methods known for the benign prostatic hyperplasia surgery include transurethral prostatectomy using ureteroscopy. Recently, less invasive procedures such as transurethral resection of the prostate using high-power laser and holmium laser enucleation of the prostate have also been performed.

In addition, recently, a surgical method has been performed in which a medical ligature passes through the prostate using a prostate ligation (UROLIFT) surgical device 300 as illustrated in FIG. 13, thereby securing the urethra by ligating the enlarged prostate. The prostate ligation (UROLIFT) surgical method is described in detail as follows.

When a benign prostatic hyperplasia occurs, as illustrated in (a) of FIG. 14, a pair of prostates A and B on both sides of the urethra become enlarged and block the urethra C. As illustrated in (b) of FIG. 14, a practitioner inserts a sheath 310 into the urethra, and as illustrated in (c) of FIG. 14, passes a medical ligature 110 through the prostates A and B, and then, as illustrated in (d) of FIG. 14, implants a first implant 200 in the upper part of the left prostate A, and as illustrated in (e) of FIG. 14, implants a second implant 200a in the upper part of the right prostate B.

Moreover, as illustrated in (f) of FIG. 14, a third implant 200b and a fourth implant 200c are also implanted in the lower parts of the left prostate A and the right prostate B, respectively. In this case, in each of the implants 200, 200a, 200b, and 200c, an outer implant 210 positioned on the outside of the prostates A and B and an inner implant 230 positioned on the urethra side are connected by a ligature 250, and the inner implant 230 compresses the prostates A and B outward by the length of the ligature 250, thereby opening the urethra.

During the above-mentioned prostatic ligation (UROLIFT) procedure, the degree of organ compression affects the position of a capsule tab and a needle trajectory. In this case, triggering the ligature at the wrong angle may lead to problems such as bladder puncture, pelvic bone puncture, or capsule penetration failure. Therefore, to prevent such surgical accidents, medical staff should be trained in various cases of benign prostatic hyperplasia.

However, there is currently no simulator that can train the prostate ligation for various cases of benign prostatic hyperplasia.

(Patent Document) Japanese Patent No. 5984104

### DISCLOSURE

### Technical Problem

The present disclosure is developed to solve the above-mentioned problems of the related art, and an object thereof is to provide a prostate hypertrophy surgery simulator that enables realistic training in surgeries such as prostate ligation for various cases of a benign prostatic hyperplasia, adjusts the level of difficulty to match actual clinical cases, enables easy monitoring of the surgical process, and facilitates evaluation of the surgical process and results.

### Technical Solution

In order to achieve the above object, the present disclosure provides a prostate surgery simulator including: an artificial structure that simulates shapes of a penis, a prostate, and a bladder, in which the prostate includes an abnormally enlarged inner gland and an outer glandular membrane that surrounds the inner gland, the penis, prostate, and bladder are internally connected through a urethra, and the artificial structure includes a structure in which a verumontanum, an obstruction kissing part, and a bladder neck are sequentially formed on the urethra toward the bladder.

### Advantageous Effects

The benign prostatic hyperplasia surgery simulator of the present disclosure enables realistic training in various prostate hyperplasia cases, including prostate ligation. Furthermore, the surgery simulator of the present disclosure allows for the surgical difficulty to be adjusted to match actual clinical cases. Furthermore, the surgery simulator of the present disclosure facilitates easy monitoring of the surgical process and facilitates the evaluation of the surgical process and results.

### DESCRIPTION OF DRAWINGS

FIGS. 1 and 2 are drawings illustrating the shape of a prostate surgery simulator of the present disclosure.

FIG. 3 is a drawing photographing the internal and external structures of the prostate surgery simulator of the present disclosure.

FIG. 4 is a drawing illustrating a surgical procedure using prostate ligation.

FIGS. 5 to 8 are drawings illustrating specific configurations of prostate surgery simulators manufactured to simulate various forms of benign prostatic hyperplasia.

FIG. 9 illustrates the external appearance of various types of prostate surgery simulators of the present disclosure.

FIG. 10 illustrates the configuration of a prostate surgery simulator further including a pelvic bone structure of the present disclosure and the configuration in which each component of the simulator is installed.

FIG. 11 illustrates the configuration of a prostate surgery simulator further including a case of the present disclosure and the configuration in which each component is installed within the case.

FIG. 12 is a drawing illustrating the configuration in which the distance between the prostate and a pelvic bone pubis is adjusted.

FIG. 13 is a perspective view illustrating one embodiment of a prostate ligation (UROLIFT) surgical device.

FIG. 14 is a cross-sectional view illustrating a procedure using the prostate ligation surgical device of FIG. 13.

### BEST MODE

The above-described purposes, features, and other advantages of the present disclosure will become more apparent by describing preferred embodiments of the present disclosure in detail with reference to the accompanying drawings. In this process, the thickness of lines and the sizes of components depicted in the drawings may be exaggerated for clarity and convenience. Furthermore, the terms described below are defined based on their functions within the present disclosure and may vary depending on the intent or custom of the user or operator. Therefore, the definitions of these terms should be based on the contents throughout this specification.

In addition, the described embodiments are provided as examples for the purpose of explaining the disclosure and do not limit the technical scope of the present disclosure.

Throughout the present specification, when a part is said to be “connected” to another part, this includes not only cases where it is “directly connected” but also cases where it is “electrically connected” with another element in between.

Throughout the present specification, when it is said that a member is located “on”, “above”, “at an upper end of”, “below”, “lower” or “at a lower end of”' another member, this includes not only cases where a member is in contact with another member, but also cases where another member exists between the two members.

Throughout the present specification, when a part is said to “include” a component, this does not mean that it excludes other components, but rather that it may include other components, unless otherwise specifically stated.

In addition, terms related to direction or position (upper side, upper surface, lower side, or the like) in the description of the embodiment of the present disclosure are set based on the arrangement state of each component illustrated in the drawing.

Hereinafter, the present disclosure will be described in detail with reference to the attached drawings.

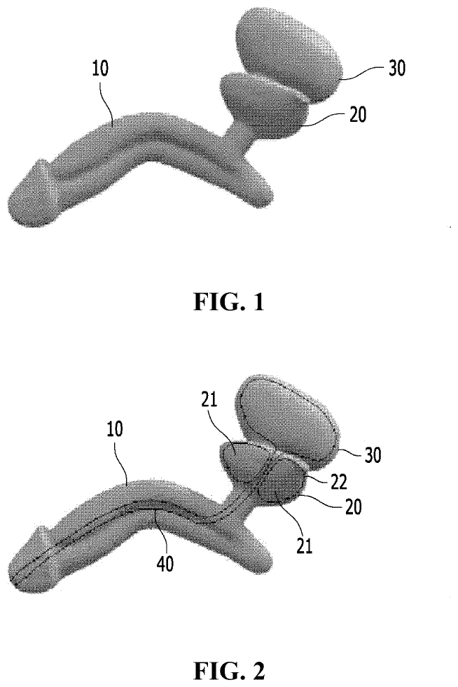

As illustrated in FIGS. 1 to 8, a prostate surgery simulator of the present disclosure includes an artificial structure that simulates shapes of a penis 10, a prostate 20, and a bladder 30, in which the prostate 30 includes an abnormally enlarged inner gland 21 and an outer glandular membrane 22 that surrounds the inner gland, and the penis, prostate, and bladder are connected internally through a urethra 40, and the artificial structure includes a structure in which a verumontanum 42, an obstruction kissing part 44, and a bladder neck 46 are sequentially formed on the urethra 40 toward the bladder.

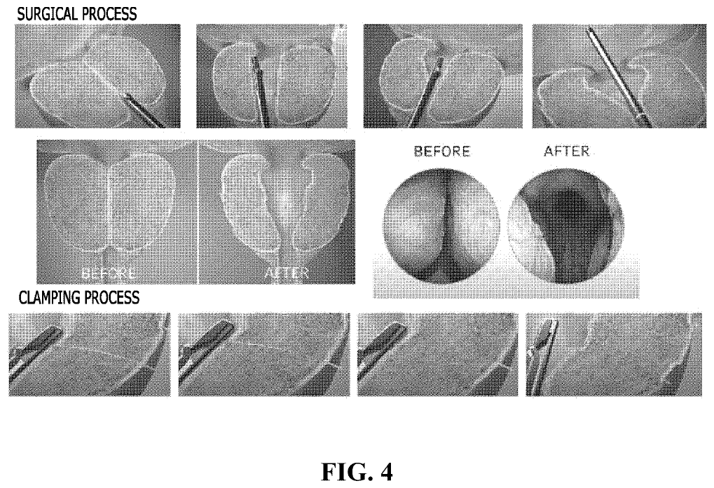

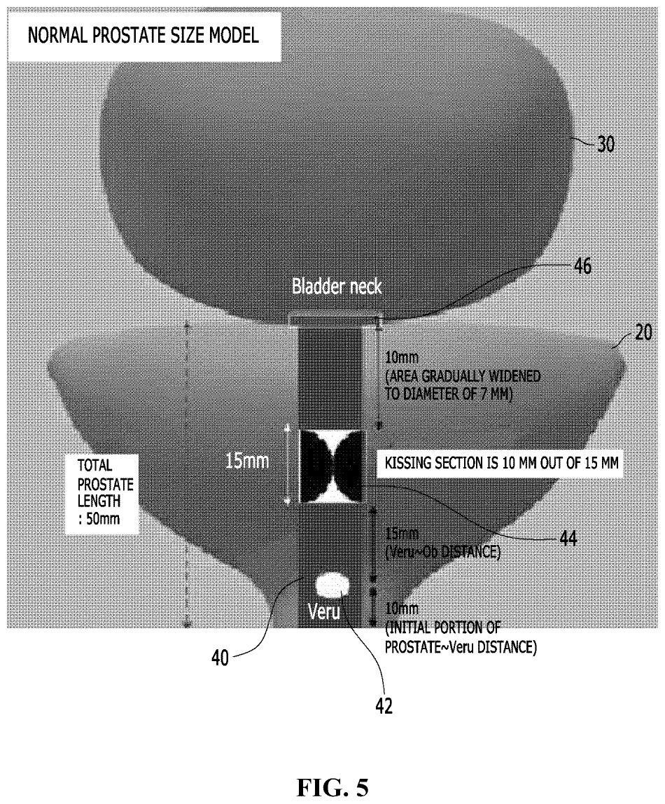

The prostate surgery simulator of the present disclosure may be provided for training in all surgeries for treating prostate diseases, and may be particularly preferably used for training in prostate ligation as illustrated in FIG. 4. The prostate surgery simulator of the present disclosure may also be usefully used for training in surgeries that apply endoscopes.

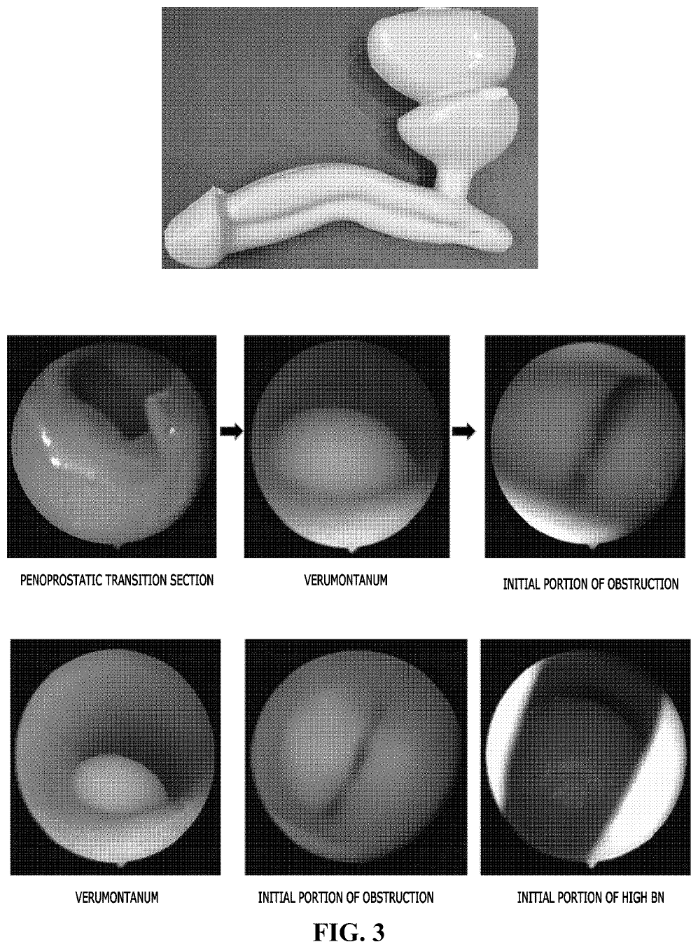

The above-mentioned verumontanum 42, obstruction kissing part 44, and bladder neck 46 are sequentially positioned in the positions as illustrated in FIGS. 5 to 8, and are formed in the shape as illustrated in FIG. 3. The prostate surgery simulator of the present disclosure includes the structure including the verumontanum 42, obstruction kissing part 44, and bladder neck 46, thereby providing a level of difficulty similar to an actual surgery and enabling more realistic training.

The verumontanum 42 is a distal protrusion located on the urethral ridge inside the prostate. The verumontanum is generally located near the area (obstruction area) where a benign prostatic hyperplasia occurs in the direction of the penis. Since the benign prostatic hyperplasia (obstruction) generally occurs 5 to 15 mm toward the bladder after the verumontanum 42, the verumontanum serves as a landmark for specifying the location of the benign prostatic hyperplasia during a prostate ligation operation. The urethral ridge refers to the space located inside a prostatic gland where a prostatic sac and two ejaculatory ducts are located.

The obstruction kissing part 44 refers to a section in the obstruction section where a prostate enlargement part is almost touching with a thickness of 0.5 mm, and the length of the section is approximately 5 mm. The obstruction section refers to a section where hypertrophy occurs inside the prostate and the urethra section is blocked, and the length of the section is approximately 15 mm.

The bladder neck 46 refers to the neck portion connecting the prostate to the bladder.

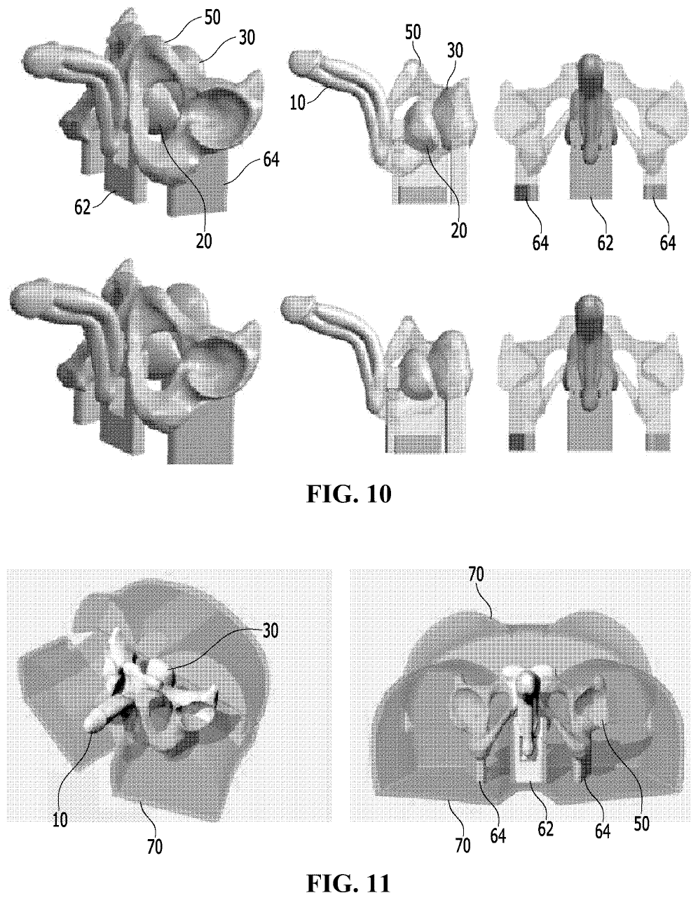

In one embodiment of the present disclosure, the prostate surgery simulator may further include a pelvic bone structure 50, as illustrated in FIG. 10. The pelvic bone structure may be custom-made and used based on individual's CT/MRI data. In addition, the pelvic bone structure may be manufactured and used by reducing the size or height or changing the angle in the same pelvic design. The pelvic bone structure may be manufactured by a method known in the art, and may be manufactured by, for example, 3D printing. The material of the pelvic bone structure is not particularly limited, but plastic (PS and ABS, or the like) types of materials may be used.

In one embodiment of the present disclosure, the prostate 20 may be made of a transparent, translucent, or opaque material. In addition, the penis 10 or bladder 30 may also be made of a transparent, translucent, or opaque material.

When the prostate 20 is made of a transparent material, for example, during a prostate ligation operation, it has the advantage of being able to accurately observe the needle trajectory with the naked eye and train. Meanwhile, when the prostate 20 is made of an opaque material, although the needle trajectory cannot be 100% visible, the position of the needle protruding outward can be confirmed with the naked eye, so that the user can immediately provide feedback on his or her surgical skills and train the ligation. Since the difficulty of surgical training is lower in a transparent form than in an opaque form, it is also possible to adjust the difficulty of training by using a transparent or opaque form.

In one embodiment of the present disclosure, as illustrated in FIGS. 10 and 11, the prostate surgery simulator may further include a stand 62 capable of holding the penis 10, the prostate 20, and the bladder 30, and a case 70 to which the stand is fixed.

In one embodiment of the present disclosure, as illustrated in FIGS. 10 and 11, the prostate surgery simulator may further include the stand 62 capable of holding the penis 10, the prostate 20, and the bladder 30, a stand 64 for holding the pelvic bone structure 50, and the case 70 to which the stands are fixed.

The case 70 is not particularly limited as long as it has a form that can hold and store the penis 10, prostate 20, and bladder 30. The case may further include a lid, and the lid may be manufactured in a transparent form.

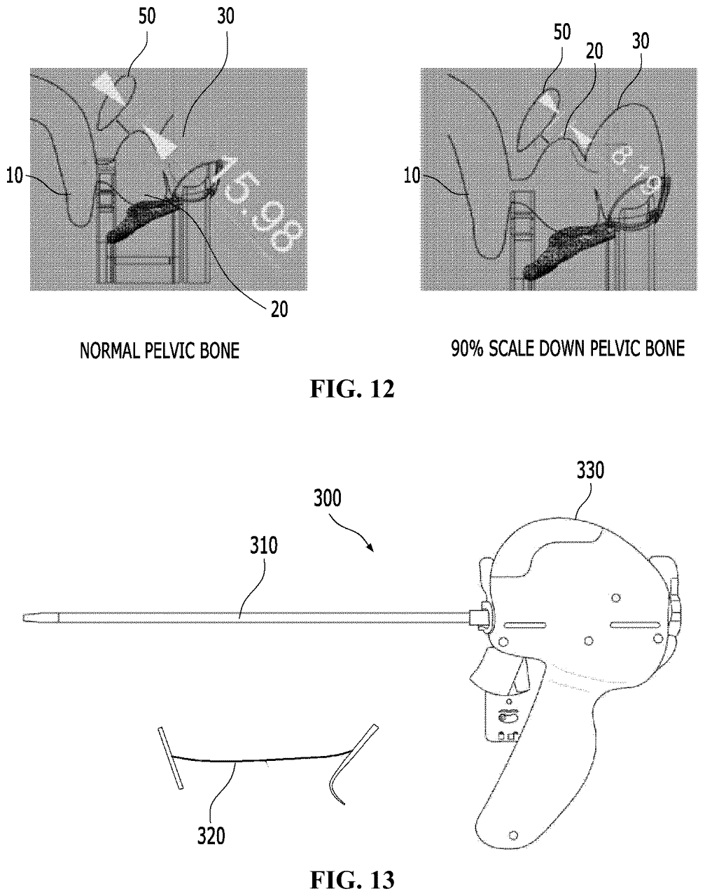

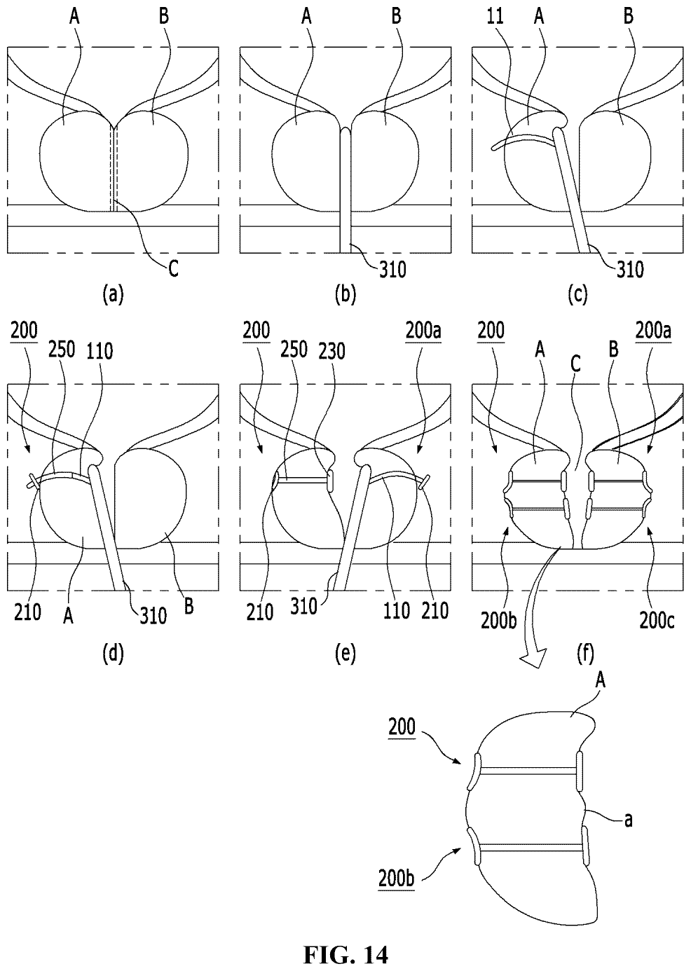

In one embodiment of the present disclosure, the prostate surgery simulator may adjust the distance between the prostate and the pelvic bone pubis, as illustrated in FIG. 12. The closer the distance between the prostate and the pelvic bone pubis, the more difficult the prostate surgery, particularly the surgery using the prostate ligation, is. Therefore, the prostate surgery simulator of the present disclosure may adjust the difficulty of the surgery by the distance adjustment configuration. For example, the distance between the prostate and the pelvic bone pubis varies depending on the size of the pelvic bone. Therefore, the distance between the prostate and the pelvic bone pubis may be adjusted by changing the size of the pelvic bone.

For effective prostate surgery training, the present disclosure provides various types of prostate surgery simulators according to the patient's prostate appearance and internal structure.

In one embodiment of the present disclosure, the prostate 20 of the prostate surgery simulator may have a general shape, as illustrated in FIG. 5. The prostate 20 simulates a case in which hypertrophy occurs in the prostate (length of the section: approximately 50 mm) of a normal adult male. For example, the verumontanum is located at a point approximately 10 mm from the end of the penis in the direction of the prostate, and an obstruction section is formed with a length of approximately 15 mm at a point approximately 15 mm from the verumontanum in the direction of the bladder. In this case, the obstruction kissing section is formed with a length of approximately 10 mm. After the obstruction section, the urethra gradually widens to a diameter of 7 mm for a section approximately 10 mm in the direction of the bladder, and then connects to the bladder neck section.

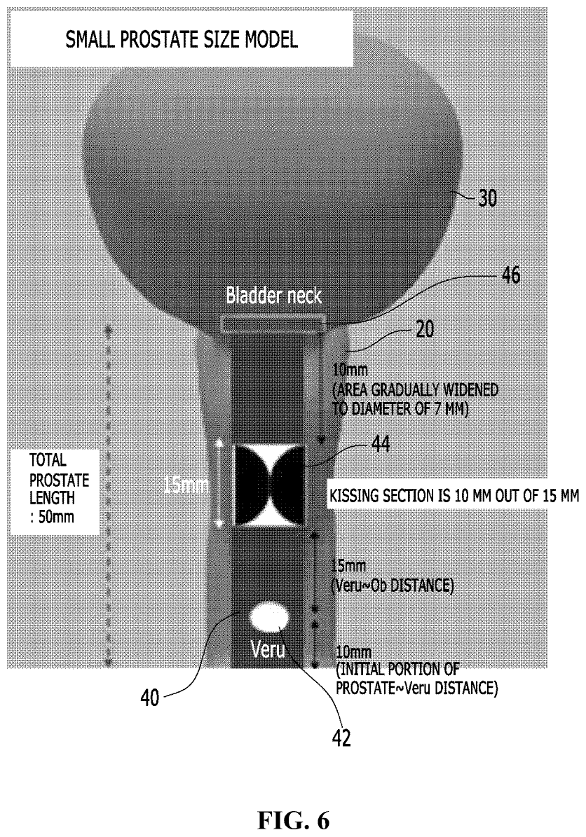

In one embodiment of the present disclosure, the prostate 20 of the prostate surgery simulator may be formed in a form in which the prostate volume is ½ to ¼ times that of a normal adult male, as illustrated in FIG. 6. That is, this is a case in which hypertrophy has occurred in a prostate ½ to ¼ times the size of a normal adult male. This case has the characteristics of having the same positions of the verumontanum and obstruction sections and the internal section of the prostate as those of a normal adult male, but having a smaller prostate volume.

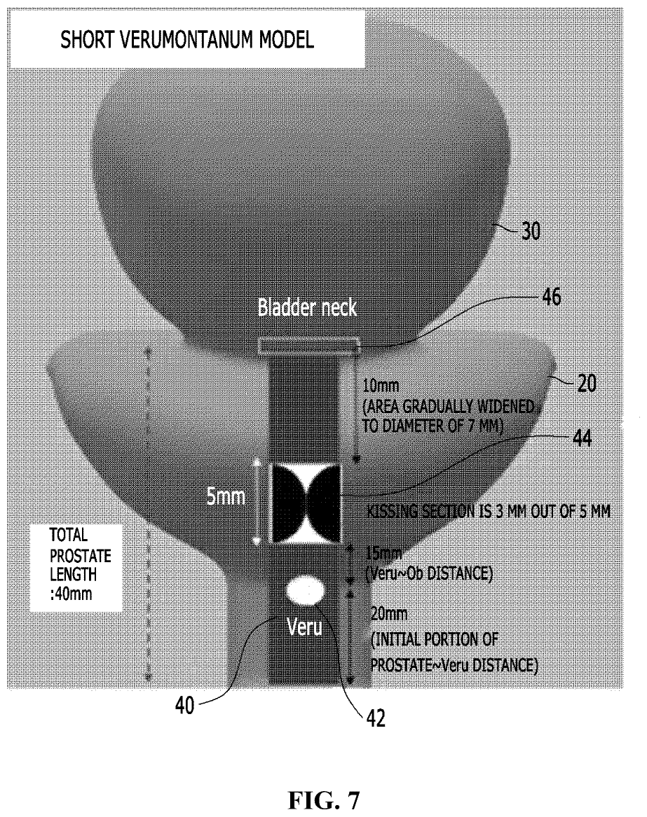

In one embodiment of the present disclosure, the prostate 20 of the prostate surgery simulator may be formed in a form in which the length of the prostate 20 is 0.7 to 0.85 times the length of the prostate of a normal adult male, as illustrated in FIG. 7. When the prostate is short as described above, the distance between the verumontanum and the obstruction kissing part is formed short. Specifically, the verumontanum is located at a point about 20 mm from the end of the penis in the direction of the prostate, and an obstruction section with a length of about 5 mm is formed at a point about 5 mm from the verumontanum in the direction of the bladder. After the obstruction section, the urethra gradually widens to a diameter of 7 mm for a section of about 10 mm in the direction of the bladder, and then connects to the bladder neck section.

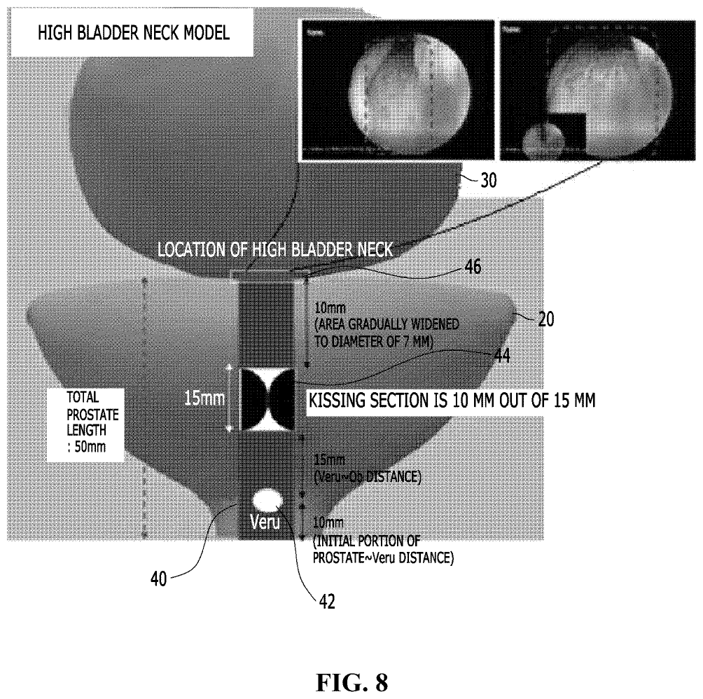

In one embodiment of the present disclosure, the bladder neck 46 of the prostate surgery simulator may be 1.3 to 2 times as tall as a normal bladder neck, as illustrated in FIG. 8. A bladder neck with a higher neck height than the normal one is referred to as a high bladder neck. This case has a similar shape to the benign prostatic hyperplasia in normal adult men, but the bladder neck is formed higher in the area leading to the bladder after the obstruction section. This case frequently occurs in Koreans.

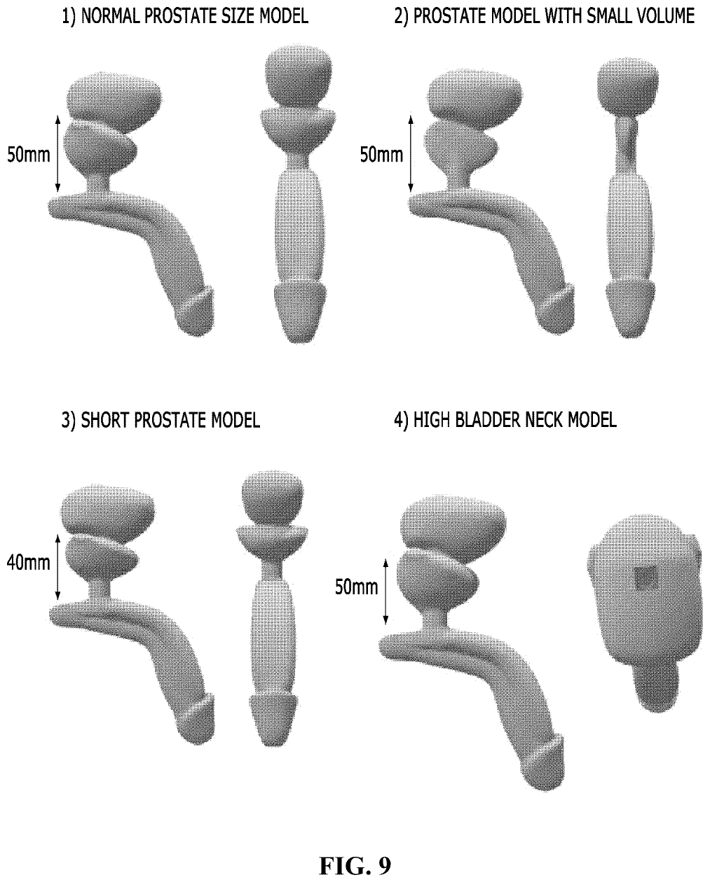

FIG. 9 illustrates the external appearance of various types of prostate surgery simulators described above.

In the prostate surgery simulator of the present disclosure, the shape and internal structure of the prostate may be customized to suit the user's desired surgical environment. For example, the size/shape of the prostate, the location/size/shape of the verumontanum, the presence/size of the high bladder neck, the presence/location/spacing of the obstruction section, the internal diameter/size of the prostate, and the angle between the prostate and the penis may be customized.

In one embodiment of the present disclosure, the inside of the bladder may have a structure in which wrinkles are formed.

In one embodiment of the present disclosure, the abnormally enlarged inner gland constituting the prostate may be made of a hydrogel. The hydrogel may include, for example, acrylamide, alginate, agarose, ammonium persulfate (APS), and N,N′-methylenebis(acrylamide).

The outer glandular membrane may be formed to be harder and tougher than the inner glandular membrane by, for example, immersing the manufactured inner glandular membrane in a FeCl3 solution.

In the prostate surgery simulator of the present disclosure, the structure including the penis, prostate, and bladder may be manufactured by including the following steps:
(a) a step of obtaining DICOM data by taking CT or MRI images of the penis, prostate, and bladder of a human body;
(b) a step of manufacturing a mold using a 3D printer using the DICOM data;
(c) a step of injecting the penis, prostate, or bladder material into the mold; and
(d) a step of removing the mold after curing the injected material.

The steps (a) and (b) may be performed by methods known in the art. The mold of the step (b) may be manufactured by dividing the mold into an inner mold and an outer mold for the internal structure of the organ, and further, the outer mold may be manufactured by dividing the outer mold into an upper mold and a lower mold.

The step (c) may be performed, for example, by injecting hydrogel into the lower mold, positioning the inner mold on the injected hydrogel, combining the upper mold with the lower mold, and injecting the remaining hydrogel into the hydrogel injection port formed in the upper mold.

The curing in the step (d) may be room temperature curing in which the curing is performed at room temperature or heat curing, but is not limited thereto. In the case of the room temperature curing, the amount of catalyst (TEMED) may be adjusted to proceed with curing. The temperature of the heat curing may be 70 to 90° C.

The structures of the penis, prostate, and bladder may be manufactured separately and then combined, or manufactured in a connected state.

In order to help understanding of the present disclosure, preferred examples are presented below. However, the following examples are only illustrative of the present disclosure, and it is obvious to those skilled in the art that various changes and modifications are possible within the scope and technical idea of the present disclosure, and it is also natural that such changes and modifications fall within the scope of the appended patent claims.

### Example 1: Manufacturing of Prostate Surgery Simulator

The structure including a penis, prostate, and bladder included in the prostate surgery simulator of the present disclosure was manufactured according to the following steps.
(a) DICOM data of the human penis, prostate, and bladder taken by CT or MRI were selected and used for mold manufacturing.
(b) Using the DICOM data, a mold with a penis, prostate, or bladder connected was produced using a 3D printer. In this case, the mold was produced by dividing the mold into an upper mold, a lower mold, and an inner mold.
(c) A portion of the hydrogel was injected into the lower mold, and the inner mold was inserted. Thereafter, the upper mold was covered, and the empty space was filled with hydrogel.
(d) After the injected hydrogel was cured, the mold was removed to manufacture the prostate surgery simulator.

While the preferred embodiments of the present disclosure have been described above, the present disclosure is not limited to the specific embodiments described above. That is, those skilled in the art to which the present disclosure pertains may make numerous changes and modifications to the present disclosure without departing from the spirit and scope of the appended claims, and equivalents of all such appropriate changes and modifications should be considered to fall within the scope of the present disclosure.

1. A prostate surgery simulator comprising:
an artificial structure that simulates shapes of a penis, a prostate, and a bladder,
wherein the prostate includes an abnormally enlarged inner gland and an outer glandular membrane that surrounds the inner gland,
the penis, prostate, and bladder are internally connected through a urethra, and
the artificial structure includes a structure in which a verumontanum, an obstruction kissing part, and a bladder neck are sequentially formed on the urethra toward the bladder.

2. The prostate surgery simulator of claim 1, further comprising a pelvic bone structure simulating a pelvic bone.

3. The prostate surgery simulator of claim 1, further comprising:
a stand that holds the penis, prostate, and bladder; and
a case to which the stand is fixed.

4. The prostate surgery simulator of claim 2, further comprising:
a stand that holds the penis, prostate, and bladder;
a stand that holds the pelvic bone; and
a case to which the stands are fixed.

5. The prostate surgery simulator of claim 2, wherein a distance between the prostate and a pelvic bone pubis is adjustable.

6. The prostate surgery simulator of claim 5, wherein the distance between the prostate and the pelvic bone pubis is adjusted by adjusting a size of the pelvic bone.

7. The prostate surgery simulator of claim 1, wherein a volume of the prostate in the prostate surgery simulator is formed to be ½ to ¼ times a volume of a prostate of a normal adult male.

8. The prostate surgery simulator of claim 1, wherein the prostate is formed with a structure whose a length is 0.7 to 0.85 times a length of a prostate of a normal adult male.

9. The prostate surgery simulator of claim 1, wherein the bladder neck in the prostate surgery simulator is 1.3 to 2 times higher than a normal bladder neck.

10. The prostate surgery simulator of claim 1, wherein the enlarged inner gland constituting the prostate is made of hydrogel, and the outer glandular membrane is formed to be harder and tougher than the inner glandular membrane.

11. The prostate surgery simulator of claim 1, wherein the prostate surgery simulator is a simulator for prostate ligation training.

12. The prostate surgery simulator of claim 1, wherein the artificial structure simulating the shapes of the penis, prostate, and bladder is manufactured by the following steps:
(a) obtaining DICOM data by taking a human penis, prostate, and bladder by CT or MRI;
(b) using a 3D printer to create a mold using the DICOM data;
(c) injecting materials of the penis, prostate, or bladder into the mold; and
(d) curing the injected material and then removing the mold.

13. The prostate surgery simulator of claim 12, wherein the mold is manufactured with a lower mold, an upper mold, and an inner mold.
